(19) United States
(12) Patent Application Publication
(10) Pub. No.: US 2021/0162519 A1
(43) Pub. Date: Jun. 3, 2021

(54) IMPELLER MANUFACTURING APPARATUS AND MANUFACTURING METHOD USING THE SAME

(71) Applicant: TCT CO., LTD., Gimhae-si Gyeongsangnam-do (KR)

(72) Inventor: Young Seog KWON, Jeonju-si Jeollabuk-do (KR)

(21) Appl. No.: 16/785,649

(22) Filed: Feb. 10, 2020

Related U.S. Application Data
(63) Continuation of application No. PCT/KR2019/016765, filed on Nov. 29, 2019.

(51) Int. Cl. B23C 3/18

(52) U.S. Cl. CPC B23C 3/18

(57) ABSTRACT

An impeller manufacturing apparatus includes an end mill driving unit having an end mill mounted thereon, a material driving unit configured to move a material, and a control device configured to control the end driving unit and the material driving unit to enable a side surface portion of the end mill to machine the material.

### TECHNICAL FIELD

The present disclosure relates to an impeller manufacturing apparatus and a manufacturing method, and a computer readable recording medium having a program recorded thereon.

### BACKGROUND ART

In a turbo machine used for high-temperature compression and high-speed transfer of water, refrigerant, gas, or the like, an impeller is a core component, and is operatively coupled with a high-speed rotating shaft to compress or transfer a fluid such as water, refrigerant, or gas.

A method for manufacturing an impeller is well known in the related-art, and for example, Korean Patent No. 10-0561204 (Mar. 8, 2006) discloses an example of the related-art impeller manufacturing method. According to the overall trend toward automation in the industry, the impellers are automatically produced by an apparatus having an end mill mounted therein and capable of five-axis machining.

FIG. 1 is a view illustrating a related-art impeller manufacturing apparatus which is capable of five-axis machining, and FIG. 2 is a view to explain an operation of performing rough cut machining with a ball end mill T in the related-art impeller manufacturing apparatus.

In particular, referring to FIG. 2, it can be seen that a cutting blade of the ball end mill T directly machines a material M. When the cutting blade of the ball end mill T machines the material in contact therewith, the ball end mill T may apply an overload to the material M, and thus may cause a deformation of the material M. In addition, since the cutting blade of the ball end mill T is weak, it may be difficult to process rapidly.

### SUMMARY

### Technical Objects

According to an embodiment of the present disclosure, there is provided an impeller manufacturing apparatus which can reduce a processing time and applies less load to a material.

According to an embodiment of the present disclosure, there is provided an impeller manufacturing method which can reduce a processing time and applies less load to a material.

According to an embodiment of the present disclosure, there is provided a computer readable medium having a program recorded thereon for executing an impeller manufacturing method for reducing a processing time and applying less load to a material in a computer.

### Technical Solving Means

An impeller manufacturing apparatus according to an embodiment of the present disclosure may include:

an end mill driving unit having an end mill mounted thereon; a material driving unit to move a material; and

a control device to control the end driving unit and the material driving unit to enable a side surface portion of the end mill to machine the material.

An impeller manufacturing apparatus according to another embodiment of the present disclosure may include:

a control device to generate an end mill position control command to control a position of an end mill (flat end mill), a posture control command to control a posture of the end mill, and a material posture control command to control a posture of a material; an end mill driving unit to move the end mill to have a position determined by the end mill position control command, and a posture determined by the posture control command; and a material driving unit to move the material to have a posture determined by the material posture control command.

In the impeller manufacturing apparatus described above, the end mill position control command, the posture control command, and the material posture control command may be generated to enable a side surface portion of the end mill to machine the material.

In the impeller manufacturing apparatus described above, the end mill position control command, the posture control command, and the material posture control command may be generated to enable a normal vector of a machining portion of the material to be machined to be perpendicular to the side surface portion of the end mill.

In the impeller manufacturing apparatus described above, the end mill position control command may be generated to move the end mill according to a trochoid shape.

In the impeller manufacturing apparatus described above, the end mill position control command, the posture control command, and the material posture control command may he generated to perform a rough cut machining step.

According to an embodiment of the present disclosure, there is provided a computer readable recording medium having a program recorded thereon to execute an impeller manufacturing method in a computer.

The impeller manufacturing method may be machining a material by using a side surface portion of an end mill mounted in an impeller manufacturing apparatus.

The impeller manufacturing method may include a step of generating an end mill position control command to control a position of the end mill mounted in the impeller manufacturing apparatus, a posture control command to control a posture of the end mill, and a material posture control command to control a posture of the material.

In the impeller manufacturing method described above, the end mill position control command, the posture control command, and the material posture control command may be generated to enable the side surface portion of the end mill to machine the material.

In the impeller manufacturing method described above, the end mill position control command, the posture control command, and the material posture control command may be generated to enable a normal vector of a ‘machining portion’ of the material to be machined to be perpendicular to the side surface portion of the end mill.

In the impeller manufacturing method described above, the end mill position control command may be generated to move the end mill according to a trochoid shape.

In the impeller manufacturing method described above, the impeller manufacturing method may be a method performing a rough cut machining step.

### Advantageous Effects

According to one or more embodiments of the present disclosure, a load applied to the material during a processing operation can be noticeably reduced. In addition, the processing time can be reduced by 40%-50% in comparison to a related-art method.

### BRIEF DESCRIPTION OF THE DRAWINGS

FIG. 1 is a view illustrating a related-art impeller manufacturing apparatus which is capable of 5-axis machining;

FIG. 2 is a view to explain an operation of performing rough cut machining with a ball end mill T in the related-art impeller manufacturing apparatus;

FIGS. 3 to 7 are views to explain an impeller manufacturing apparatus 100 according to an embodiment of the present disclosure; and

FIG. 8 is a view to explain an impeller manufacturing method according to an embodiment of the disclosure.

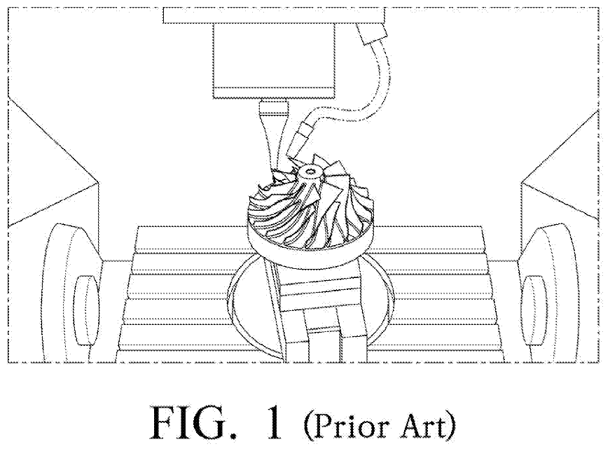

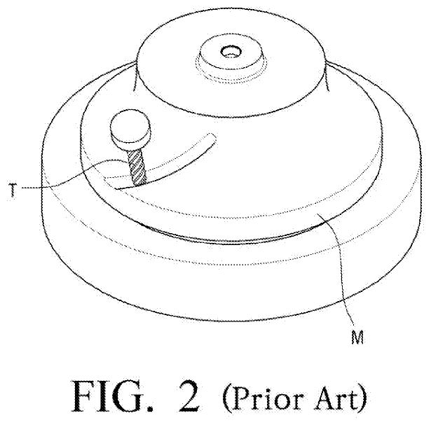

### EXPLANATION OF REFERENCE NUMERALS

100: impeller manufacturing apparatus, 10: material

20: control device, 30: end mill driving unit

31: end mill, 33: end mill jig

40: material driving unit, 41: material fixing unit

5: normal vector

### DETAILED DESCRIPTION OF THE INVENTION

It will be understood that, when an element is referred to as being “on” another element, the element can be directly formed on another element or a third element may be interposed therebetween. In the drawings, thickness of elements is exaggerated for easy understanding of technical features.

If the terms such as “first” and “second” are used to describe elements, these elements should not be limited by such terms. These terms are used for the purpose of distinguishing one element from another element only. The exemplary embodiments include their complementary embodiments.

As used herein, the singular forms “a”, “an” and “the” are intended to include the plural forms as well, unless the context clearly indicates otherwise. It will be further understood that the terms “comprise” and/or “comprising,” When used in this specification, do not preclude the presence or addition of one or more other components.

Hereinafter, exemplary embodiments will be described in greater detail with reference to the accompanying drawings. The matters defined in the description, such as detailed construction and elements, are provided to assist in a comprehensive understanding of the exemplary embodiments. However, it is apparent that the exemplary embodiments can be carried out by those of ordinary skill in the art without those specifically defined matters. In the description of the exemplary embodiment, certain detailed explanations of related art are omitted when it is deemed that they may unnecessarily obscure the essence of the inventive concept.

Definition of Terms

In the following description, the term “program” refers to a “set of commands suitable for processing by a computer.”

In the following description, the expression “a program performing (or executing) a certain operation (or step)” refers to “causing a computer to perform or execute a certain operation (or step).”

In the following description, the expression “a program being installed in a certain apparatus” refers to a state in which the program is stored in a memory device controllable by the apparatus and is executed by a computer processor controllable by the apparatus.

In the following description, a “computer” includes a computer processor and a memory device, an operating system, firmware, an application program, a communication unit, and other resources, and herein, the operating system (OS) may operatively connect other hardware, firmware, or application programs (for example, a management program). The communication unit refers to a module that includes software and hardware to exchange data with an outside. In addition, the computer processor and the memory device, the operating system, the application program, the firmware, the communication unit, and the other resources may be operatively connected with one another directly or via a communication network.

In the following description, a “server” refers to a computer that is configured to include one or more memories (not shown), one or more computer processors (not shown), and one or more programs (not shown), and herein, the one or more programs may be stored in a memory included in the server and may be configured to be executed by the one or more processors, and the one or more memories, the one or more computer processors, and the one or more programs may be physically positioned in the same apparatus and may be connected with one another directly or via a communication network,

In the following description, a “communication network” refers to all facilities supporting data to be exchanged wiredly and/or wirelessly-including all programs, machines, electric and electronic devices, base stations, and communication cables supporting communication-, and the communication network includes a wide area network (WAN), a metropolitan area network (MAN), a local area network (LAN), and/or a personal area network (PAN), and supports data to be exchanged wiredly and/or wirelessly.

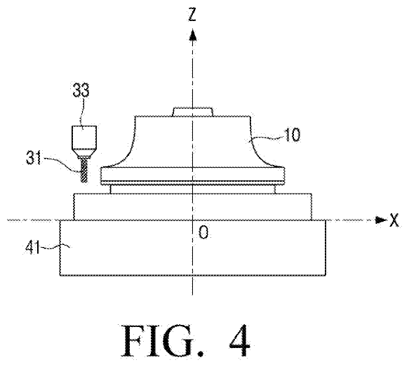

In the following description, a “material” refers to an object to be machined by an impeller manufacturing apparatus 100 according to an embodiment, and for example, may be formed with a material such as metal. FIG. 4 illustrates an example of a typical shape of the material 10.

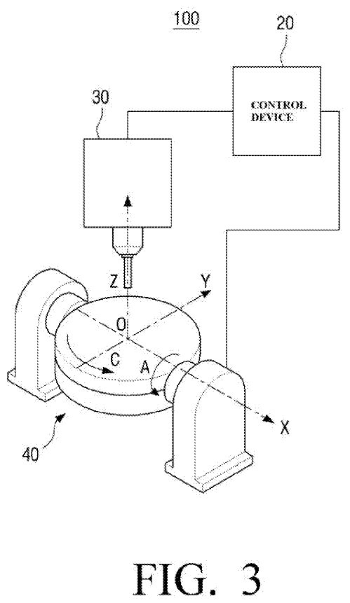

FIGS. 3 to 7 are views to explain the impeller manufacturing apparatus 100 according to an embodiment of the present disclosure.

Referring to these drawings, the impeller manufacturing apparatus 100 according to an embodiment of the present disclosure may include a control device 20, an end mill driving unit 30, and a material driving unit 40.

The impeller manufacturing apparatus 100 according to the present embodiment may machine the material 10 on five dimensions (“five-axis machining”). For example, a material fixing unit 41 may move on two dimensions, and simultaneously, the end mill driving unit 30 may move on three dimensions.

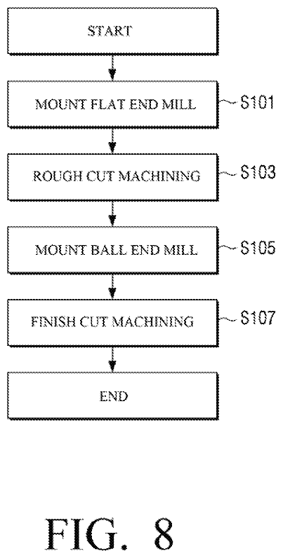

Preferably, the impeller manufacturing apparatus 100 according to the present embodiment may be applied to a rough cut machining or roughing step. As will be described below with reference to FIG. 8, the impeller manufacturing apparatus 100 according to the present embodiment may perform the rough cut machining or roughing step, and additionally, may perform a finish cut machining or finishing step, For example, when a flat end mill 31 is mounted in the impeller manufacturing apparatus 100 according to the present embodiment, the rough cut machining or roughing step may be performed, and, when a ball end mill 31 is mounted, the finish cut machining or finishing step may be performed.

Control Device 20

According to the present embodiment, the control device 20 may control operations of the end mill driving unit 30 and the material driving unit 40, simultaneously, to cause a side surface portion of the end mill 31 to machine the material 10.

The control device 20 may generate various commands to operate the end mill driving unit 30 and the material driving unit 40. These commands may include an operating command to operate the end mill and control commands.

For example, the control device 20 may generate an end mill position control command to control a position of the end mill 31, a posture control command to control a posture of the end mill 31, and a. material posture control command to control a posture of the material 10. The posture of the material 10 and the position and the posture of the end mill 31 may be determined by these control commands, such that a. normal vector of a portion of the material 10 to he machined (hereinafter, a “machining portion”) perpendicularly enters the side surface portion of the end mill 31. In the present embodiment, the end mill 31 may be a flat end mill 31 that can machine using the side surface portion.

The control device 20 controls operations of the end mill driving unit 30 and the material driving unit 40 to enable the side surface portion of the end mill 31 to machine all of the “machining portions” of the material 10. Specifically, the control device 20 controls the posture of the material 10 and the position and the posture of the end mill 31, such that the side surface portion of the end mill 31 can machine the material 10 in contact with the machining portion with a normal vector of each of the “machining portions” being perpendicular to the side surface portion of the end mill 31 when all of the “machining portions” of the material 10 are machined. In order to bring the side surface portion of the end mill 31 into contact with the “machining portion” with the normal vector of the “machining portion” being perpendicular to the side surface portion of the end mill 31, the posture of the material 10 may be fixed and the position and the posture of the end mill 31 may be adjusted, or all of the posture of the material 10 and the position and the posture of the end mill 31 may be adjusted. That is, according to what shape the machining portion is or how the machining portion is arranged, the control device 20 may control the side surface portion of the end mill 31 to be brought into contact with the machining portion by adjusting only the position and the posture of the end mill 31, or may control the side surface portion of the end mill 31 to be brought into contact with the machining portion by adjusting not only the position and the posture of the end mill 31 but also the posture of the material 10.

The control device 20 may be a computer in which programs (not shown) are executed. The control device 20 may have a program (not shown) installed therein to execute an impeller manufacturing method, and this program may be installed in the control device 20 explained with reference to FIGS. 3 to 7 and may be configured to perform overall operations.

The program for executing the impeller manufacturing method may be configured to execute overall operations of the control device 20 explained in the detailed description. That is, the program for executing the impeller manufacturing method may control the operations of the end mill driving unit 30 and the material driving unit 40 to enable the side surface portion of the end mill 31 to machine all of the “machining portions” of the material 10. Specifically, the program for executing the impeller manufacturing method may generate an end mill position control command to control a position of the end mill 31, a posture control command to control a posture of the end mil 31, and a material posture control command to control a posture of the material 10, and may control the operations of the end mill driving unit 30 and the material driving unit 40.

The program for executing the impeller manufacturing method may be stored in a memory device embedded in the control device 20 (a computer processor readable medium, for example, a random access memory (RAM), a read only memory (ROM), a hard disk drive (HDD), or a solid state drive (SSD)), and may be executed by a computer processor (not shown).

Alternatively, the program for executing the impeller manufacturing method may be installed in a server (not shown) connected with the control device 20 wiredly or via a communication network, and may be executed, and the server (not shown) may transmit commands (including a position control command, a posture control command, and a material posture control command) to operate and to control the end mill driving unit 30 and the material driving unit 40 to the control device 20, and the control device 20 may operate the end mill driving unit 30 and the material driving unit 40 based on these commands.

The control device 20 may be connected with the end mill driving unit 30 and the material driving unit 40 directly through a wire or through a communication network. The commands generated by the control device 20 may be converted into formats of signals recognizable by the end mill driving unit 30 and the material driving unit 40, and may be provided to the end mill driving unit 30 and the material driving unit 40. A component for converting the command into the format of the signal recognizable by the end mill driving unit 30 and the material driving unit 40 may be a program which is called a driver, for example. The driver may be installed and executed in the control device 20, or may be installed in and performed by a separately provided device (not shown).

The end mill position control command to control the position of the end mill 31 conforms to a trochoid shape. The trochoid refers to a curve traced out by a point positioned inside or outside a circle that rolls along a straight line. That is, the control device 20 controls the position of the end mill 31 to move along the trochoid shape.

The posture control command to control the posture of the end mill 31 and the material posture control command to control the posture of the material 10 are determined according to a shape to be machined. For example, Korean Patent Publication No. 10-0833112 (Method for Generating Roughing Path for Manufacturing Impeller) discloses a method for generating a machining path. The disclosure of Korean Patent Publication No. 10-0833112 is incorporated as a part of the specification of the present application without conflicting with the present disclosure.

End Mill Driving Unit 30

The end mill driving unit 30 moves the end mill 31 to have the position determined by the end mill position control command and the posture determined by the posture control command, and rotates the end mill 31 in the determined position and posture to machine the material 10.

The end mill 31 coupled to the end mill driving unit 30 may move in a three-dimensional space as shown in FIG. 3. In the present embodiment, the position or posture of the end mill 31 is defined by the XYZ coordinate system, but this is merely an example, and the position or posture of the end mill 31 may be defined by other three-dimensional coordinate systems for example, the spherical coordinate system). Since the configuration of the end mill driving unit 30 is well-known related-art technology, a detailed description thereof is omitted.

The end mill driving unit 30 receives the end mill position control command the end mill posture control command from the control device 20, and moves the end mill 31 to have the position and the posture according to the received control commands. As described above, the end mill driving unit 30 moves the end mill 31 to cause the side surface portion of the end mill 31 to machine the machining portion.

Material Driving Unit 40

The material driving unit 40 moves the material 10 to have the posture determined by the material posture control command.

The material fixing unit 41 may rotate in both directions (“A direction) with reference to the X-axis, and may rotate in both directions (“C direction) with reference to the Z-axis. In this way, the material fixing unit 41 may move by a combination of the A direction and the C direction. The material 10 driving unit may include an A direction driving unit (not shown) to rotate the material fixing unit 41 in the A direction, and a C direction driving unit (not shown) to rotate the material fixing unit 41 in the C direction, although they are not illustrated in FIG. 3, and the material fixing unit 41 is moved on two dimensions by these driving units. Since configurations of the A direction driving unit (not shown) and the C direction driving unit (not shown) are well-known related-art technology, a detailed description thereof is omitted.

Although it is illustrated in the present embodiment that the material fixing unit 41 is configured to move on two dimensions, this is merely an example and the material fixing unit 41 may be configured to move on three dimensions. Relative positions and postures of the material 10 and the end mill 31 are important. That is, it is important to control the positions and the postures of the end mill 31 and the material 10 simultaneously, to enable the side surface portion of the end mill 31 to machine the material 10 in contact therewith.

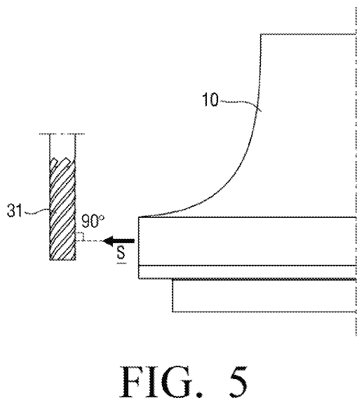

FIGS. 4 and 5 illustrate an exemplary state when the impeller manufacturing apparatus 100 according to an embodiment of the present disclosure starts a machining operation. Referring to these drawings, it can be seen that the side surface portion of the end mill 31 is ready to machine a “machining portion” of the material 10.

When the normal vector of the “machining portion” of the material 10 is defined as S, the control device 20 may control the position of the end mill 31, the posture of the end mill 31, and the posture of the material 10, simultaneously, such that the normal vector S perpendicularly enters the side surface portion of the end mill 31. That is, the control device 20 controls the end mill driving unit 30 and the material driving unit 40 to enable the side surface portion of the end mill 31 to machine the “machining portion.”

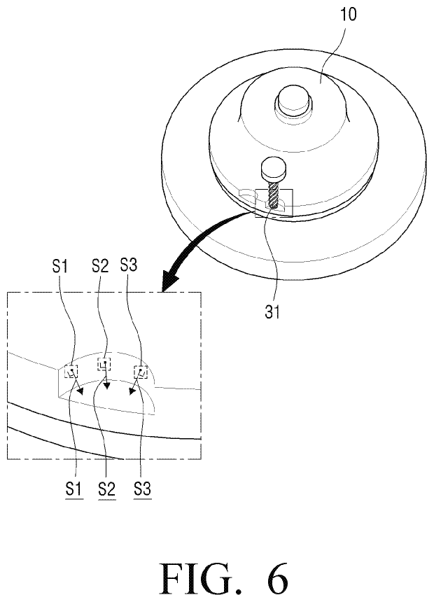

Referring to FIG. 6, examples of the “machining portions” are illustrated. When the normal vectors of the machining portions are defined as S1, S2, and S3, the position of the end mill 31, the posture of the end mill 31, and the posture of the material 10 are simultaneously controlled, such that these vectors perpendicularly enter the side surface portion of the end mill 31. Specifically, when the machining portion S1 is machined, the position of the end mill 31, the posture of the end mill 31, and the posture of the material 10 are simultaneously controlled, such that the normal vector S1 of the machining portion S1 perpendicularly enters the side surface portion of the end mill 31. In addition, when the machining portion S2 is machined, the position of the end mill 31, the posture of the end mill 31, and the posture of the material 10 are simultaneously controlled, such that the normal vector S2 of the machining portion S2 perpendicularly enters the side surface portion of the end mill. The other machining portions are machined in the same way.

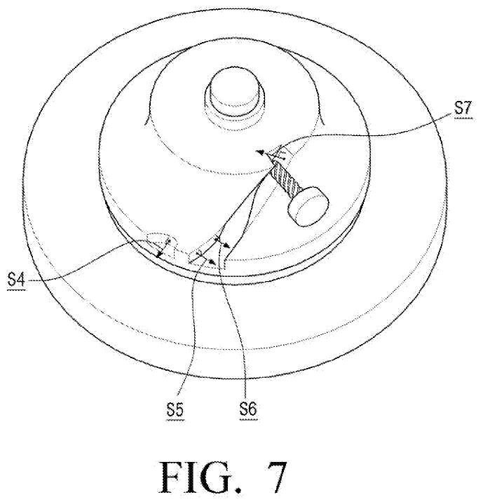

Referring to FIG. 7, other examples of the “machining portions” are illustrated, When the normal vectors of the machining portions are defined as S4, S5, S6, and S7, the position of the end mill 31, the posture of the end mill 31, and the posture of the material 10 are simultaneously controlled, such that these vectors perpendicularly enter the side surface portion of the end mill 31. The other machining portions are machined in the same way as described above with reference to FIG. 6.

FIG. 8 is a view to explain an impeller manufacturing method according to an embodiment of the present disclosure.

Referring to FIG. 8, the impeller manufacturing method according to an embodiment of the present disclosure may include a step of mounting a flat end mill 31 in an impeller manufacturing apparatus (S101), a rough cut machining step (S103), a step of mounting a ball end mill 31 in the impeller manufacturing apparatus 100 (S105), and a finish cut machining step (S107).

The step of mounting the flat end mill 31 in the impeller manufacturing apparatus 100 (S101) is a step of mounting the flat end mill 31 in the impeller manufacturing apparatus 100 described above with reference to FIGS. 3 to 7.

The rough cut machining step (S103) is performed by the impeller manufacturing apparatus 100 having the flat end mill 31 mounted therein in step S101. In the rough cut machining step (S103), the impeller manufacturing apparatus 100 having the flat end mill 31 mounted therein operates to enable the side surface of the flat end mill 31 to machine the material 10. For example, the impeller manufacturing apparatus 100 machines the material 10 while controlling the posture of the material 10 and the position and the posture of the end mill 31 to enable the normal vector of the “machining portion” of the material 10 to be perpendicular to the side surface portion of the end mill 31.

In the rough cut machining step (S103), the impeller manufacturing apparatus 100 having the flat end mill 31 mounted therein machines the material 10 while controlling the position and the posture of the end mill 31 and the posture of the material 10 to enable the side surface portion of the end mill 31 to machine all of the “machining portions” of the material 10. Specifically, when the impeller machining apparatus 100 having the flat end mill 31 mounted therein machines all of the “machining portions” of the material 10 in the rough cut machining step (S103), the impeller manufacturing apparatus 100 machines the material 10 while controlling the posture of the material 10 and the position and the posture of the end mill 31, such that the normal vector of each “machining portion” is perpendicular to the side surface portion of the end mill 31.

The impeller manufacturing apparatus 100 performing the rough cut machining step (S103) may have a program installed therein to perform the rough cut machining step (S103). The rough cut machining step (S103) may include a step of generating an end mill position control command to control the position of the end mill 31, a posture control command to control the posture of the end mill 31, and a material posture control command to control the posture of the material 10, and the end mill position control command, the end mill posture control command, and the material posture control command are to enable the side surface portion of the end mill 31 to machine the material 10.

As described above, the end mill position control command, the end mill posture control command, and the material posture control command are to machine the “machining portion” with the normal vector of the “machining portion” being perpendicular to the side surface portion of the end mill 31. Regarding a detailed description of the rough cut machining step (S103), reference is made to the description of the impeller manufacturing apparatus 100 explained above with reference to FIGS. 3 to 7.

The impeller manufacturing apparatus 100 having the ball end mill 31 mounted therein in step S105 may be the impeller manufacturing apparatus 100 used in the rough cut machining step (S103), or may be a different impeller manufacturing apparatus 100. When the impeller manufacturing apparatus 100 used in step S103 is used in step S105, the ball end mill 31 is mounted in the impeller manufacturing apparatus 100 instead of the flat end mill 31 mounted in step S101. The finish cut machining step (S107) is a step of machining precisely to suit to a dimension to be machined. Since the finish cut machining is well-known related-art technology, a detailed description thereof is omitted.

It will be understood by those skilled in the art that various modifications and changes may be made from the description of the specification, and therefore, the scope of the present disclosure is defined not by the detailed description of the embodiments but by the appended claims and the equivalents to the claims.

What is claimed is:

1. An impeller manufacturing apparatus comprising:
an end mill driving unit having an end mill mounted thereon;
a material driving unit configured to move a material; and
a control device configured to control the end driving unit and the material driving unit to enable a side surface portion of the end mill to machine the material.

2. The impeller manufacturing apparatus of claim 1, wherein the control device is configured to control a position and a posture of the end mill and a posture of the material, such that a normal vector of a machining portion of the material to be machined is perpendicular to the side surface portion of the end mill.

3. The impeller manufacturing apparatus of claim 2, wherein the position of the end mill is moved according to a trochoid shape.

4. The impeller manufacturing apparatus of claim 2, wherein machining the material by the control device is performing a rough cut machining step.

5. A computer readable recording medium having a program recorded thereon to execute an impeller manufacturing method in a computer, the impeller manufacturing method comprising controlling a side surface portion of an end mill mounted in an impeller manufacturing apparatus to machine a material.

6. The computer readable recording medium of claim 5, wherein the impeller manufacturing method comprises controlling a position and a posture of the end mill and a posture of the material, such that a normal vector of a machining portion of the material to be machined is perpendicular to the side surface portion of the end mill.

7. The computer readable recording medium of claim 6, wherein the position of the end mill is moved according to a trochoid shape.

8. The computer readable recording medium of claim 6, wherein the impeller manufacturing method comprises performing a rough cut machining step.
